(19) United States
(12) Patent Application Publication
(10) Pub. No.: US 2013/0066547 A1
(43) Pub. Date: Mar. 14, 2013

(54) METHOD FOR DETERMINING AT LEAST ONE TRAVELLING ROUTE OF A VEHICLE AND NAVIGATION SYSTEM FOR A VEHICLE

(71) Applicants: Thomas SCHRAMM, Mainz (DE); Ralf RATHMACHER, Schmitten im Taunus (DE)

(72) Inventors: Thomas SCHRAMM, Mainz (DE); Ralf RATHMACHER, Schmitten im Taunus (DE)

(73) Assignee: GM GLOBAL TECHNOLOGY OPERATIONS LLC, Detroit, MI (US)

(21) Appl. No.: 13/606,103

(22) Filed: Sep. 7, 2012

(30) Foreign Application Priority Data
Sep. 7, 2011 (DE) 10 2011 112 683.3

(51) Int. Cl. G01C 21/00

(52) U.S. Cl. 701/408; 701/400; 701/527; 701/538

(57) ABSTRACT

A method is provided for determining at least one travelling route of a vehicle. The method includes, but is not limited to a predetermining of at least two criteria for a travelling route of the vehicle from a starting point to a target point takes place. The at least two criteria in this case are selected from the group consisting of a travelling duration, a travelling distance and an energy consumption. In addition, a defining of a weighting factor for each of the at least two predetermined criteria takes place. Furthermore, a determining of at least one travelling route from the starting point to the target point from a quantity of possible travelling routes based on the at least two predetermined criteria and as a function of the defined weighting factors of the at least two predetermined criteria takes place.

### CROSS-REFERENCE TO RELATED APPLICATION

This application claims priority to German Patent Application No. 10 2011 112 683.3, filed Sep. 7, 2011, which is incorporated herein by reference in its entirety.

### TECHNICAL FIELD

The technical field relates to a method for determining at least one travelling route of a vehicle, a navigation system for a vehicle, a vehicle having a navigation system, a computer program product and a computer-readable medium.

### BACKGROUND

From DE 10 2007 017 240 A1 a method for determining one or a plurality of travelling routes from a quantity of possible travelling routes from a starting point to a travelling destination is known. To reduce the quantity of the travelling routes, a plurality of cost functions are applied one after the other. A sequence for the respective application of the cost function is predetermined by a user.

In view of the foregoing, it is desirable to provide a method for determining at least one travelling route of a vehicle, a navigation system for a vehicle, a vehicle having a navigation system, a computer program product and a computer-readable medium, which makes possible an improved possibility of the route planning for a user. In addition, other desirable features and characteristics will become apparent from the subsequent summary and detailed description, and the appended claims, taken in conjunction with the accompanying drawings and this background.

### SUMMARY

A method is provided for determining at least one travelling route of a vehicle comprises the following steps. A predetermining of at least two criteria for a travelling route of the vehicle from a starting point to a target point to be determined takes place. The at least two criteria are selected from the group consisting of a travelling duration, a travelling distance and an energy consumption. In addition, a determining of a weighting factor for each of the at least two predetermined criteria takes place. Furthermore, a determining of at least one travelling route from the starting point to the target point out of a quantity of possible travelling routes based on the at least two predetermined criteria and as a function of the defined weighting factors of the at least two predetermined criteria takes place.

The method for determining at least one travelling route of a vehicle makes possible a provision of improved possibilities for the route planning for a user. This takes place through the determining of a weighting factor for each of the predetermined criteria and the determining of the at least one travelling route based on the predetermined criteria and as a function of the defined weighting factors for the criteria. Because of this, a travelling route can be determined, which is adapted to the highest degree possible to preferences and requirements of the user, for example the driver of the vehicle. In addition, this increases in advantageous manner the acceptance and satisfaction of the user when using the method for route determination, for example with a navigation system. Through the criterion of the energy consumption of the vehicle on the travelling route to be determined, the user can additionally travel a route which is improved or optimized with respect to ecological aspects. Here, low energy consumption in the form of low fuel consumption leads to a reduced emission of exhaust gases, in particular of carbon dioxide.

The determining of the at least one travelling route in an embodiment takes place subject to the use of a fuzzy logic method. In a further embodiment, the determining of the at least one travelling route takes place subject to the use of an artificial neuronal network. Both embodiments are suitable to a particular degree for a determining of a travelling route from a quantity of possible travelling routes.

The determining of the at least one travelling route can additionally take place based on determined data regarding a congestion frequency and/or regarding a current traffic situation on at least a part of the quantity of possible travelling routes. For example, a congestion frequency can be additionally stored as additional information in digital map data. Data regarding a current traffic situation, in particular regarding traffic impairments, can for example be determined by means of digital radio data services, in particular by means of so-called TMC messages (TMC, traffic message channel). The mentioned configurations make it possible in an advantageous manner to include congestion frequencies or traffic impairments when determining the travelling route, and thus advantageously a further improved route determination.

The determining of the weighting factor for each of the at least two predetermined criteria is carried out in an embodiment by means of a user input, for example by means of an input in a navigation system. Because of this, the user can adapt the route planning with each new determining process based on the situation.

In a further embodiment, in addition a determining of a current user of the vehicle takes place, the determining of the weighting factor for each of the at least two predetermined criteria takes place based on the determined current user of the vehicle. For example, previously stored values of the weighting factors, which were entered by the user during a previous route determining process, can be called up after a completed identification of the user. This is based on the consideration that a user typically maintains the weighting factors, as a result of which a repeated inputting of the weighting factors by the user can be omitted.

The determining of the current user of the vehicle takes place for example based on at least one user-specific setting of at least one component of the vehicle. In particular, the determining of the current user of the vehicle can take place based on a user-specific setting of a seat of the vehicle and/or of a user-specific setting of a vehicle key. This makes possible a simple and reliable identification of the user, for example of a driver of the vehicle. Furthermore, the determining of the current user of the vehicle can take place through a user input.

In a further embodiment, a classification of a driving behavior of a current driver of the vehicle takes place. The determining of the weighting factor for each of the at least two predetermined criteria in this embodiment takes place based on the determined driving behavior. This is based on the consideration that the respective driving behavior of the driver makes possible to draw conclusions as to the driver's preferences and requirements in terms of the travelling route and the driving behavior or the driving style can be utilized for determining the weighting factors.

The starting point of the travelling route to be determined can be defined by means of determining a current position of the vehicle. In a further configuration, the starting point of the travelling route to be determined can be defined with a user input.

The application additionally relates to a navigation system for a vehicle. The navigation system comprises a first determining device, which is designed for predetermining at least two criteria for a travelling route of the vehicle from a starting point to a target point to be determined The at least two criteria are selected from the group consisting of a travelling duration, a travelling distance and an energy consumption. In addition, the navigation system comprises a second determining device, which is designed for defining a weighting factor for at each of the at least two predetermined criteria. Furthermore, the navigation system comprises a third determining device, designed for determining at least one travelling route from the starting point to the target point from a quantity of possible travelling routes based on the at least two predetermined criteria and as a function of the defined weighting factors of the at least two predetermined criteria.

Furthermore, the application relates to a vehicle having a navigation system according to the mentioned embodiment. The navigation system and the vehicle comprise the advantages already mentioned in connection with the method according to the application, which at this point are not mentioned again to avoid repetitions. In addition, a computer program product, which, when it is executed on a computer unit of a navigation system for a vehicle, instructs the computer unit to carry out the following steps. The computer unit is instructed for predetermining at least two criteria for a travelling route of the vehicle from a starting point to a target point to be determined The at least two criteria in this case are selected from the group consisting of a travelling duration, a travelling distance and an energy consumption. In addition, the computer unit is instructed for determining a weighting factor for each of the at least two predetermined criteria. In addition, the computer unit is instructed for determining at least one travelling route from the starting point to the target point from a quantity of possible travelling routes based on the at least two predetermined criteria and as a function of the defined weighting factors of the at least two predetermined criteria.

Furthermore, the application relates to a computer-readable medium, on which a computer program product according to the mentioned embodiment is stored. The computer program product and the computer-readable medium comprise the advantages already mentioned in connection with the method according to the application, which are not mentioned again at this point to avoid repetitions.

In the abovementioned embodiments, the vehicle is for example a motor vehicle, in particular a passenger car or a commercial vehicle.

### BRIEF DESCRIPTION OF THE DRAWINGS

The present invention will hereinafter be described in conjunction with the following drawing figures, wherein like numerals denote like elements, and:

FIG. 1 shows a flow diagram of a method for determining at least one travelling route of a vehicle according to a first embodiment;

FIG. 2 shows a flow diagram of a method for determining at least one travelling route of a vehicle according to a second embodiment;

FIG. 3 shows a flow diagram of a method for determining at least one travelling route of a vehicle according to a third embodiment; and

FIG. 4 shows a navigation system for a vehicle according to an embodiment.

### DETAILED DESCRIPTION

The following detailed description is merely exemplary in nature and is not intended to limit application and uses. Furthermore, there is no intention to be bound by any theory presented in the preceding background or summary or the following detailed description.

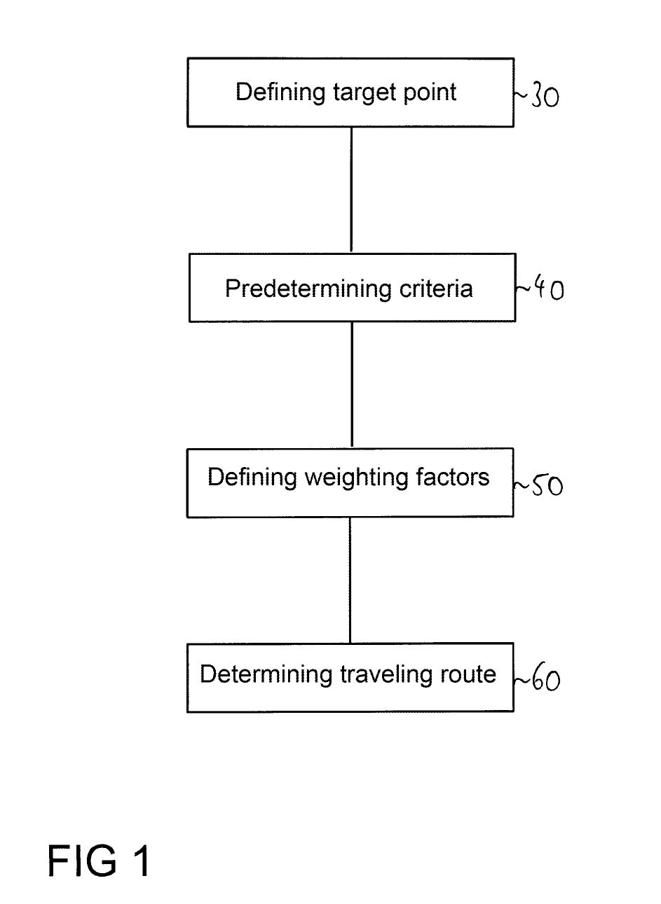

FIG. 1 shows a flow diagram of a method for determining at least one travelling route of a vehicle according to a first embodiment. Here the vehicle is for example a passenger car. In the shown embodiment, a determining of a target point of the travelling route of the vehicle to be determined takes place in a step 30. The target point of the travelling route to be determined in this case is defined in the shown embodiment with a user input.

In a step 40, a predetermining of at least two criteria for the travelling route of the vehicle from a starting point to the target point to be determined takes place. The at least two criteria in this case are selected from the group consisting of a travelling duration, a travelling distance and an energy consumption, in particular a fuel consumption of the vehicle on the travelling route to be determined. The predetermined criteria can be presented to a user for example by means of a display device, in particular with a display of a navigation system. The starting point of the travelling route to be determined is defined, for example, with determining a current position of the vehicle or by means of a user input.

In a step 50, a determining of a weighting factor for each of the at least two predetermined criteria takes place. This can take place with a user input. Furthermore, if a determining of a current user of the vehicle additionally takes place, the determining of the weighting factors can take place based on the determined current user of the vehicle. For example, upon driver identification, the navigation system can automatically load or retrieve the values of the weighting factors stored for this driver at the start of the trip. Here, the user or drive identification can take place based on a user-specific setting of a seat of the vehicle and/or of a vehicle key. The values of the weighting factors for each of the at least two predetermined criteria defined in the step 50 can be additionally stored, as a result of which these are available during a new determining process.

In a step 60, a determining of at least one travelling route from the starting point to the target point from a quantity of possible travelling routes based on the at least two predetermined criteria and as a function of the defined weighting factors of the at least two predetermined criteria takes place. The determining of the at least one travelling route for example takes place subject to the use of a fuzzy logic method or subject to the use of an artificial neuronal network. If in the process a plurality of travelling routes are determined which are suitable taking into account the weighting factors, these can be presented to the user who can select the desired travelling route. Following this, a navigation process for the vehicle commences based on the determined travelling route.

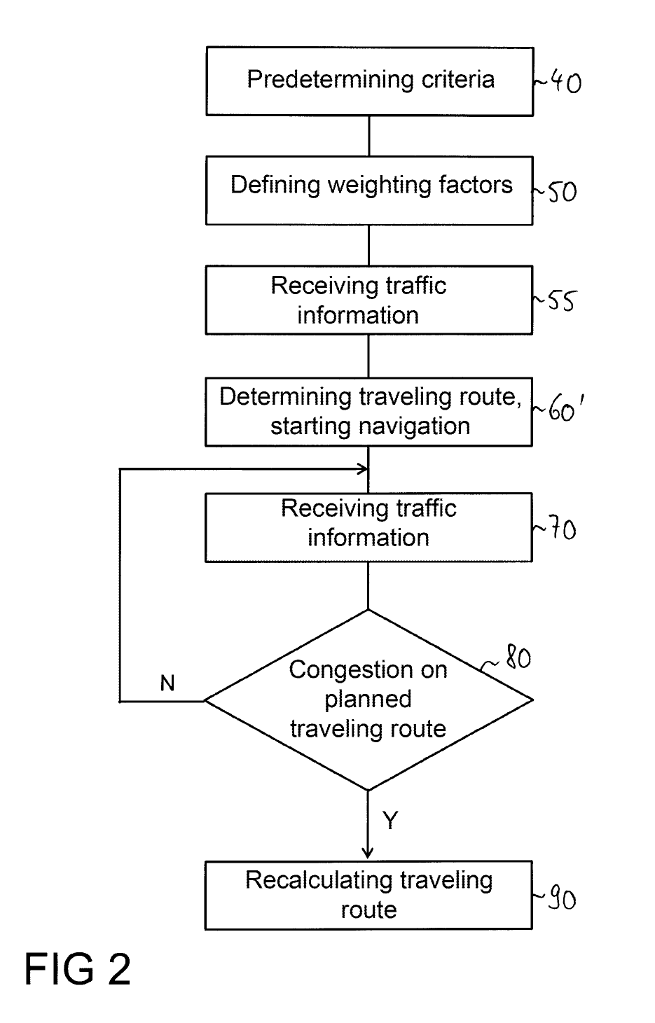

FIG. 2 shows a flow diagram of a method for determining at least one travelling route of a vehicle according to a second embodiment. Again, the vehicle is for example a passenger car. In a step 40, a predetermining of at least two criteria for a travelling route of the vehicle for a starting point to a target point to be determined corresponding to the step 40 of the first embodiment shown in FIG. 1 takes place. In addition, a defining of a weighting factor for each of the at least two predetermined criteria corresponding to the step 50 of the embodiment shown in FIG. 1 takes place. Furthermore, in the second embodiment, a receiving of traffic information, for example via a so-called traffic message channel takes place in a step 55. The traffic information in this case includes data regarding a current traffic situation on at least a part of a quantity of possible travelling routes.

In a step 60′, a determining of at least one travelling route from the starting point to the target point from the quantity of possible travelling routes takes place. This takes place based on the at least two predetermined criteria and as a function of the defined weighting factors of the at least two predetermined criteria. In addition, the determining of the at least one travelling route in the shown embodiment based on the determined data regarding the current traffic situation takes place. Following this, the navigation process based on the determined travelling route takes place.

Here, a renewed receiving of traffic information, for example again via the traffic message channel, takes place during the navigation process in a step 70. Based on the traffic information received in the step 70, it is determined in a step 80 if at least in a section or on a part section of the determined travelling route there are traffic impairments, in particular congestions. If it determined in the step 80 that there are no traffic impairments, the steps 70 and 80 are executed by repetition.

If however it is determined in the step 80 that at least on a section of the planned travelling route there are traffic impairments in the form of traffic congestions, a recalculating of the travelling route based on the determined data regarding the current traffic situation takes place in a step 90. Here, the at least two predetermined criteria and the defined weighting factors of the at least two predetermined criteria are again taken into account with the route planning

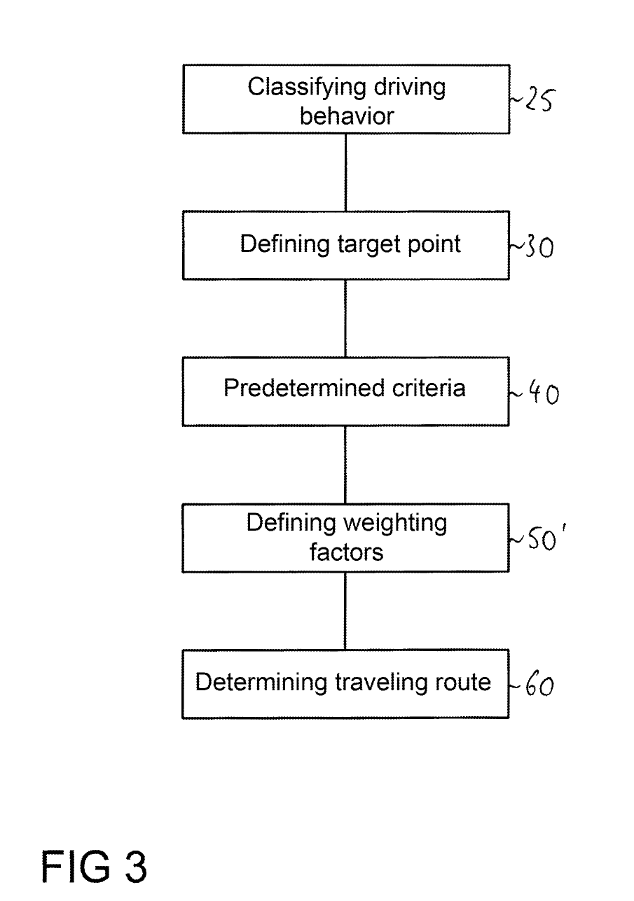

FIG. 3 shows a flow diagram of a method for determining at least one travelling route of a vehicle according to a third embodiment. The vehicle is for example a passenger car. In a step 25, a classification of a driving behavior of a current driver of the vehicle takes place in the shown third embodiment. For example, the speed of the vehicle and from this an acceleration and/or braking behavior of the driver is determined for this purpose. Here, the classification of the driving behavior can in particular include a distinction between a sportive and a moderate driving style.

In a step 30, a defining of a target point for a travelling route of the vehicle to be determined corresponding to the step 30 of the first embodiment shown in FIG. 1 takes place. Furthermore, in a step 40, a predetermining of at least two criteria for the travelling route of the vehicle from a starting point to the target point to be determined according to the step 40 of the first embodiment show in FIG. 1 takes place.

In a step 50′, a defining of a weighting factor for each of the at least predetermined criteria takes place. Here, the defining of the weighting factors in the shown embodiment takes place based on the determined driving behavior of the current driver. In a step 60, a determining of at least one travelling route from the starting point to the target point from a quantity of possible travelling routes based on the at least two predetermined criteria and as a function of the defined weighting factors of the at least two predetermined criteria corresponding to the step 60 of the first embodiment shown in FIG. 1 again takes place.

The shown embodiments thus make possible a substantially simultaneous optimization with respect to the determining of the travelling routes with respect to a plurality of criteria. The user, for example the driver of the vehicle, can assign weighting factors to different criteria in the shown embodiments, dependent on the importance of these factors to the user. The vehicle or the navigation system of the vehicle calculates the optimum travelling route subject to the simultaneous or parallel consideration of the weighting factors.

Thus, a driver can indicate for example that on a scale of 0, synonymous to no importance, to 10, synonymous with very important, he assigns the criterion of time the weighting factor 7, the criterion of course the weighting factor 2 and the criterion of fuel consumption, the weighting factor 10. As result, a travelling route is calculated which means a comparatively short travelling time insofar as no major detour is travelled, seeing that the weighting factor for the criterion of course is 2, and thus not entirely negligible. In this example, pass roads, severe uphill gradients and/or routes through city areas are avoided when possible seeing that the criterion of fuel consumption is very greatly weighted. If the user or driver would like to have a route that is exclusively optimized with respect to one criterion, he predetermines the weighting factor 10 for example for this criterion and the weighting factors 0 for the other remaining criteria.

The preset values in this case can be stored specifically for a driver, so that upon driver identification at the start of the trip the navigation system in a configuration automatically loads the values stored for this driver. Here, the method for determining the at least one travelling route according to the shown embodiments, can in particular include a recalculation of the route based on TMC messages.

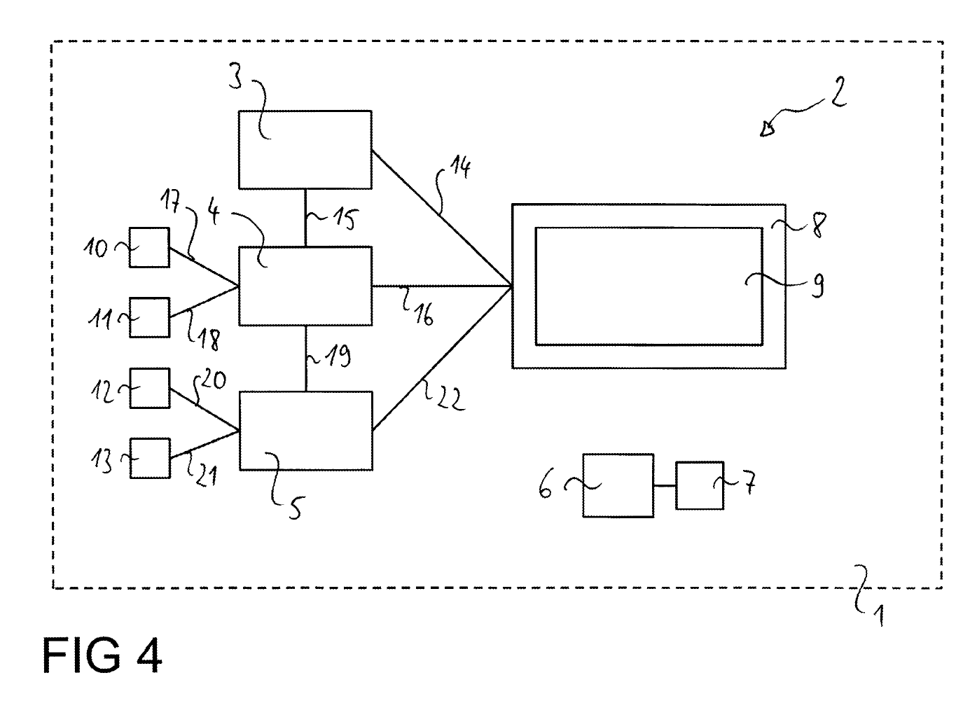

FIG. 4 shows a navigation system 2 for a schematically represented vehicle 1 according to an embodiment of the application. The vehicle 1 is for example a motor vehicle, in particular a passenger car. In the shown embodiment, the navigation system 2 comprises a first determining device 3, which is designed for predetermining at least two criteria for a travelling route of the vehicle one from a starting point to a target point to be determined. The at least two criteria in this case are selected from the group consisting of a travelling duration, a travelling distance and an energy consumption of the vehicle 1 on the travelling route to be determined To this end, the first determining device 3 is connected to a display device 8 of the navigation system 2 via a signal line 14, as a result of which the predetermined criteria can be displayed to a user of the navigation system 2 the display device 8.

In addition, the navigation system 2 comprises a second determining device 4, which is designed for defining a weighting factor for each of the at least two predetermined criteria. The second determining device 4 to this end is connected to the first determining device 3 via a signal line 15. Furthermore, the second determining device 4 is connected to the display device 8 via a signal line 16, wherein by means of a user input the weighting factors for the predetermined criteria can be defined on a touch screen 9 of the display device 8.

Furthermore, a defining of the weighting factors based on a determined driving behavior of a current driver of the vehicle 1 can take place. To this end, the second determining device 4 is connected to a sensor 10, which is designed for determining a current speed of the vehicle 1, via a signal line 17. Based on speed data determined by means of the sensor 10 a classification of the driving behavior with respect to an acceleration and braking behavior of the current driver of the vehicle 1 can take place. Furthermore, the defining of the weighting factor for each of the at least two predetermined criteria by determining a current user of the vehicle 1 can take place. To this end, the second determining device 4 is connected to a sensor 11 via a signal line 18, wherein the sensor 11 for example can determine a user-specific setting of a driver's seat of the vehicle.

The navigation system 2 furthermore comprises a third determining device 5, which is designed for determining at least one travelling route from the starting point to the target point from a quantity of possible travelling routes. The determining of the at least one travelling route in this case takes place based on the at least two predetermined criteria and as a function of the defined weighting factors of the at least two predetermined criteria. To this end, the third determining device 5 is connected to the second determining device 4 via a signal line 19.

Furthermore, the determining of the travelling route in the shown embodiment additionally takes place based on determined data regarding a congestion frequency and/or regarding a current traffic situation on at least a part of the quantity of possible travelling routes. To this end, the third determining device 5 is connected to a storage device 12 via a signal line 20, wherein map data stored on the storage device 12 include a congestion frequency for defined lanes or lane sections. In addition to this, the third determining device 5 to this end is connected via a signal line 21 to a receiving device 13, which is designed for receiving, for example, TMC messages. The determined travelling route or information regarding the determined travelling route can be output by means of the display device 8. To this end, the third determining device 5 is connected to the display device 8 via a signal line 22.

In the shown embodiment, the navigation system 2 additionally comprises a computer unit 6 and a computer-readable medium 7. The computer-readable medium 7 a computer program product is stored, which, when it is executed on the computer unit 6, instructs the computer unit 6 to execute the steps mentioned in connection with the embodiments of the method according to the application, in particular the steps of the embodiments shown in the FIGS. 1 to 3, with the elements mentioned there. To this end, the computer unit 6 is directly or indirectly connected to the respective elements in a manner which is not shown in more detail.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for determining a travelling route of a vehicle, comprising:
predetermining at least two criteria for the travelling route of the vehicle from a starting point to a target point;
defining a weighting factor for each of the at least two criteria;
determining the travelling route from the starting point to the target point from a quantity of possible travelling routes based on the at least two criteria and as a function of the weighting factor for each of the at least two criteria.

2. The method according to claim 1, wherein at least one of the at least two criteria is a travelling duration.

3. The method according to claim 1, wherein at least one of the at least two criteria is a travelling distance.

4. The method according to claim 1, wherein at least one of the at least two criteria is an energy consumption.

5. The method according to claim 1, wherein the determining of the travelling route is performed with fuzzy logic.

6. The method according to claim 1, wherein the determining of the weighting factor for each of the at least two criteria is received from a user input.

7. The method according to claim 1, further comprising determining a current user of the vehicle,
wherein the defining of the weighting factor for each of the at least two criteria is at least partially based on the current user of the vehicle.

8. The method according to claim 7, wherein the determining of the current user of the vehicle is at least partially based on at least one user-specific setting of at least one component of the vehicle.

9. The method according to claim 8, wherein the determining of the current user of the vehicle is at least partially based on a user-specific setting of a seat of the vehicle.

10. The method according to claim 1, further comprising determining a classification of a driving behavior of a current driver of the vehicle, wherein the defining of the weighting factor for each of the at least two criteria is at least partially based on the driving behavior.

11. The method according to claim 1, wherein the starting point of the travelling route is at least partially defined with a determining a current position of the vehicle.

12. The method according to claim 1, wherein the starting point of the travelling route is at least partially defined with a user input.

13. A navigation system for a vehicle, comprising:
a first determining device that is configured to determine at least two criteria for a travelling route of the vehicle from a starting point to a target point;
a second determining device that is configured to determine a weighting factor for each of the at least two criteria; and
a third determining device that is configured to determining the travelling route from the starting point to the target point from a quantity of possible travelling routes based at least in part on the at least two criteria and at least partially as a function of the weighting factor for each of the at least two criteria.

14. The navigation system according to claim 13, wherein at least one of the at least two criteria is a travelling duration.

15. The navigation system according to claim 13, wherein at least one of the at least two criteria is a travelling distance.

16. The navigation system according to claim 13, wherein at least one of the at least two criteria is an energy consumption.

17. A computer readable medium embodying a computer program product, said computer program product comprising:
a program for determining a travelling route of a vehicle, the program configured to:
predetermine at least two criteria for the travelling route of the vehicle from a starting point to a target point;
define a weighting factor for each of the at least two criteria;
determine the travelling route from the starting point to the target point from a quantity of possible travelling routes based on the at least two criteria and as a function of the weighting factor for each of the at least two criteria.

18. The computer readable medium according to claim 17, wherein the travelling route is at least partially based on determined data regarding a congestion frequency on at least a part of the quantity of possible travelling routes.

19. The computer readable medium according to claim 17, wherein the travelling route is at least partially based on determined data regarding a current traffic situation on at least a part of the quantity of possible travelling routes.

20. The computer readable medium according to claim 17, wherein the weighting factor for each of the at least two criteria is received from a user input.
